(19) United States
(12) Patent Application Publication
(10) Pub. No.: US 2023/0113801 A1
(43) Pub. Date: Apr. 13, 2023

(54) ADJUSTABLE OPTICAL ARRANGEMENT

(71) Applicant: TRUMPF Lasersystems for Semiconductor Manufacturing GmbH, Ditzingen (DE)

(72) Inventors: Dieter Burger, Vaihingen an der Enz (DE); Oliver Erichson, Ludwigsburg (DE); Jonathan Mueller, Stuttgart (DE); Matthias Wecker, Leonberg- Hoefingen (DE)

(21) Appl. No.: 18/064,302

(22) Filed: Dec. 12, 2022

Related U.S. Application Data
(63) Continuation of application No. PCT/EP2020/066868, filed on Jun. 18, 2020.

(51) Int. Cl. G02B 7/182; H01S 3/00

(52) U.S. Cl. CPC G02B 7/1825; H01S 3/0071

(57) ABSTRACT

An adjustable optical arrangement includes an optics mount, an optical element held at the optics mount, a holding structure having a ball joint for receiving the optics mount, a ball joint holding the optics mount at the holding structure, a first adjustment device configured to pivot the optics mount with respect to the holding structure about a first axis, and a second adjustment device configured to pivot the optics mount with respect to the holding structure about a second axis. The ball joint is disposed between the optical element and the first and the second adjustment device.

### CROSS REFERENCE TO RELATED APPLICATIONS

This application is a continuation of International Application No PCT/EP2020/066868 (WO 2021/254614 A1), filed on Jun. 18, 2020. The aforementioned applications are hereby incorporated by reference herein.

### FIELD

The invention relates to an adjustable optical arrangement having an optics mount, an optical element held at the optics mount, a holding structure, wherein the optics mount is held at the holding structure in a ball joint, wherein a first adjustment device is provided to pivot the optics mount with respect to the holding structure about a first axis and wherein a second adjustment device is provided to pivot the optics mount with respect to the holding structure about a second axis.

### BACKGROUND

Such an arrangement is known from U.S. Pat. No. 3,897,139 A. In this known arrangement, a mirror is arranged at the center of a square mounting plate. A ball joint and two adjustment devices are arranged at the corners of the square mounting plate and connect the mounting plate to a holding structure. The ball joint and the two adjustment devices are located at the same distance from the mirror and in each case arranged immediately adjacent to the mirror.

### SUMMARY

In an embodiment, the present disclosure provides an adjustable optical arrangement having an optics mount, an optical element held at the optics mount, a holding structure having a ball joint for receiving the optics mount, a ball joint holding the optics mount at the holding structure, a first adjustment device configured to pivot the optics mount with respect to the holding structure about a first axis, and a second adjustment device configured to pivot the optics mount with respect to the holding structure about a second axis. The ball joint is disposed between the optical element and the first and the second adjustment device

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic sectional view of an optical arrangement according to the invention with an optical element, which is held at an optics mount and is adjustable with respect to a holding structure via two adjustment devices, wherein the holding structure engages around the optics mount between a ball joint and the adjustment devices, which are located further away from the optical element;

FIG. 2 shows an abstracted schematic of the adjustable optical arrangement of FIG. 1; and

FIG. 3 shows a schematic illustration of an apparatus for generating extreme ultraviolet radiation, in which laser radiation is directed from a light source onto a target via two adjustable optical arrangements according to FIG. 1 in a manner such that extreme ultraviolet radiation is emitted.

### DETAILED DESCRIPTION

It is an aspect of the present disclosure to specify an optical arrangement with improved accessibility for adjusting an optical element.

According to an aspect of the disclosure, an adjustable optical arrangement is provided. The optical arrangement has an optics mount and an optical element held at the optics mount. The optical element may be a lens. The optical element is preferably a mirror.

The optical arrangement furthermore has a holding structure. The optics mount is held at the holding structure. During the adjustment, the alignment of the optics mount with the optical element with respect to the holding structure is changed and set in a defined manner. A ball joint is provided for holding the optics mount at the holding structure. The ball joint permits a movement of the optics mount with respect to the holding structure in all rotational degrees of freedom but restricts all translational degrees of freedom.

Two adjustment devices are provided to make it possible for a defined alignment of the optics mount relative to the holding structure to be established. Using a first adjustment device, the optics mount can be pivoted with respect to the holding structure about a first axis. Using a second adjustment device, the optics mount can be pivoted with respect to the holding structure about a second axis. The first and the second axis are in principle not aligned parallel to one another. The first and second axes can enclose an angle of between 10° and 170°. Angles of approximately 90° are advantageous. The angle between the first and the second axis can preferably be between 75° and 105°. The first and the second axis extend in principle through the ball joint. Tensioning of the optics mount during adjustment can thereby be avoided. The first and the second adjustment device preferably define the alignment of the optics mount relative to the holding structure merely with respect to rotations about the first and second axis; all other degrees of freedom are typically in each case not restricted by the first or second adjustment device.

According to an aspect of the disclosure, the ball joint is arranged between the optical element and the first and the second adjustment device. The two adjustment devices are, in other words, arranged on the other side of the ball joint as viewed from the optical element. The ball joint is consequently arranged more closely to the optical element than the adjustment devices. This simplifies the access to the two adjustment devices for setting the alignment of the optical element by actuating one or both of the adjustment devices. In particular, a gas-tight and/or optically dense screen may be provided between the two adjustment devices and the optical element, preferably close to the ball joint, without thereby limiting the access to the adjustment devices. The first axis can be defined by a straight line through the ball joint and the second adjustment device. The second axis can be defined by a straight line through the ball joint and the first adjustment device.

The ball joint advantageously lies as closely as possible to an optical center point of the optical element. The ball joint is typically arranged just outside the external diameter of the optical element. It is also conceivable for the ball joint to be arranged behind the optical element if the optical element is not transmissive, i.e. a mirror.

The distances of the two adjustment devices from the ball joint are advantageously of the same magnitude. The distances of the two adjustment devices from the ball joint are typically greater than the distance of the ball joint from the optical center point of the optical element, preferably at least twice as large.

The optics mount can be guided by a longitudinally rigid guide element at the holding structure. A defined rotational position of the optics mount relative to the holding structure is established by the guide element with respect to a third axis. The third axis in principle does not extend parallel to the first and the second axis but preferably perpendicularly to the first and/or the second axis. In particular, the third axis can extend perpendicularly to the angle bisector between the first and the second axis. This can reduce the stress on the ball joint. The third axis typically extends through the ball joint.

The longitudinal direction in which the guide element has a stiff design advantageously extends at an angle of in each case at least 30° with respect to the first and the second axis. The guide element can in particular extend from the first to the second adjustment device, or the longitudinal direction can extend parallel to a connection line between the adjustment devices.

The guide element is preferably embodied in the form of a leaf spring. A leaf spring can be provided cost-effectively and be easily attached to the holding structure and the optics mount. At the same time, a leaf spring allows precise guidance of the optics mount relative to the holding structure. The leaf spring is stiff, that is to say not appreciably deformable, in its longitudinal direction. The leaf spring is soft, i.e. significantly deformable, at least in one direction extending transversely to the longitudinal direction. The leaf spring is typically torsionable about its longitudinal axis.

Viewed from the ball joint, the guide element is advantageously arranged behind the first and/or the second adjustment device. Owing to the large distance of the guide element from the ball joint, a particularly accurate alignment of the optics mount with respect to the second axis can be achieved. In addition, this can simplify mounting of the optical arrangement.

In order to restrict the third rotational degree of freedom of the ball joint, one of the adjustment devices could alternatively restrict two degrees of freedom and be embodied for example in the manner of a hinge.

With particular preference provision is made for the optics mount to project through a cutout in the holding structure. The holding structure can then contribute to sealing or screening off a space in which the optical element is arranged with respect to an environment in which the adjustment devices are arranged—and are easily accessible for adjustment purposes.

The holding structure preferably engages on all sides around the optics mount between the ball joint and the two adjustment devices. This can result in a particularly compact construction. This can furthermore simplify the connection of the optical arrangement to a further structure, for example to a housing.

A gas seal is preferably arranged between the optics mount and the holding structure. A protective gas atmosphere in the region of the optical element can be separated by the gas seal from ambient air in the region of the adjustment devices. The gas seal lies against the optics mount and against the holding structure in principle in a touching manner.

An optical screen can be provided at the cutout. The optical screen prevents radiation from emerging from the region of the optical element into the environment to which operating staff has access. The optical screen is preferably embodied with mutually overlapping sheet-metal elements. At least one of the sheet-metal elements can be held at the holding structure. At least one further sheet-metal element can be held at the optics mount.

In order to cause only small movements at the gas seal or the optical screen during the adjustment, the cutout of the holding structure through which the optics mount extends is preferably arranged close to the ball joint. The gas seal and/or parts of the optical screen can be arranged directly at the cutout.

The optics mount can have a coolant channel. By guiding coolant through the coolant channel, the optics mount and in particular the optical element can be cooled. Coolant, in particular cooling water, can be guided through the coolant channel from a first coolant connector of the optics mount to a second coolant connector of the optics mount. The coolant channel can extend directly past the optical element, wherein the optical element can also form a wall of the coolant channel.

The first and/or the second adjustment device can be embodied for performing a length change. The first and/or the second adjustment device is preferably embodied with a first or second adjustment screw and a first or second retaining nut. In this way, a particularly precise alignment of the optics mount with the optical element relative to the holding structure can be set. In addition, undesirable independent changes in the setting can be effectively avoided by way of such adjustment devices.

The first and/or the second adjustment screw can be embodied with a rotationally elliptical, in particular spherical, head section, which is supported in a conical receptacle, preferably the optics mount. In this design, a line contact between the adjustment screw or the adjustment screws and the (respective) receptacle is produced. The line contact ensures sufficient rigidity to ensure the precise alignment of the optics mount with the optical element even in the case of shocks or impacts. In addition, the line contact reduces the contact pressure between the head section and the respective receptacle.

The first and/or the second retaining nut can be embodied with a rotationally elliptical, in particular spherical, contact surface, which is supported in a conical receptacle, preferably the holding structure. In this design, a line contact between the retaining nut or the retaining nuts and the (respective) receptacle is produced. The line contact ensures sufficient rigidity to ensure the precise alignment of the optics mount with the optical element even in the case of shocks or impacts. In addition, the line contact reduces the contact pressure between the contact surface and the respective receptacle.

Preferably, the optics mount and the holding structure are preloaded away from one another. In this way, the optics mount and the holding structure can be coupled to the adjustment devices without play and without tensioning the optics mount. The first and/or the second adjustment device can have a first or second spring element. During adjustment of the first or second adjustment device, the respective spring element can be compressed or expanded. The first or second spring element can engage around the first or second adjustment screw. The first or second spring element can be embodied in the form of a, preferably cylindrical, coil spring. The pre-tensioning can ensure the head sections and the contact surfaces reliably lie against the respective receptacles.

A preloading force at each of the two adjustment devices can be, for example, at least 100 N, preferably at least 120 N, with particular preference at least 150 N. With preloading forces of such magnitude, the play-free and precise alignment can be ensured even in the case of vibrations and other forces acting on the optics mount, for example by way of cooling water hoses. The preloading force at the adjustment devices is typically in each case less than 500 N. Overloading of the adjustment devices can therefore be avoided.

The ball joint can be embodied with a fixing nut that is screwed onto a stud of the holding structure and has a rotationally elliptical, in particular spherical, joint surface that is supported in a further conical receptacle of the optics mount. Play-free mounting of the optics mount, which is insensitive to vibrations and forces acting on it, at the holding structure can be established in this way. Typically, a third spring element is provided, which preloads the optics mount and the holding structure at the ball joint away from one another, preferably wherein the spring element engages around the stud. The third spring element can be a, preferably cylindrical, coil spring. A preloading force at the ball joint can be at least 100 N, preferably at least 120 N, with particular preference at least 150 N. With a preloading force of such magnitude, the play-free and precise alignment can be ensured even in the case of vibrations and other forces acting on the optics mount, for example by way of cooling water hoses. The preloading force at the ball joint is typically less than 500 N. Overloading of the ball joint can therefore be avoided. The preloading force at the ball joint is typically greater than the preloading force at the adjustment devices. The third spring element can have a greater rigidity than the first and the second spring element. Since the centroid of the optics mount is usually located significantly more closely to the ball joint, its strong load can hereby be compensated.

The optical arrangement can furthermore have a laser light source for emitting a laser beam and a target, wherein the optical element is arranged in the beam path of the laser beam in order to direct the laser beam onto the target. By irradiating the target with a laser beam, it is possible, for example, to obtain extreme ultraviolet radiation (wavelength between 10 nm and 121 nm).

Further features and advantages of the invention are apparent from the description, the claims and the drawing. According to the invention, the features mentioned above and below can in each case be used individually, or a plurality thereof can be used in arbitrary, expedient combinations. The embodiments shown and described should not be understood to be an exhaustive list but rather have exemplary character for illustrating the invention.

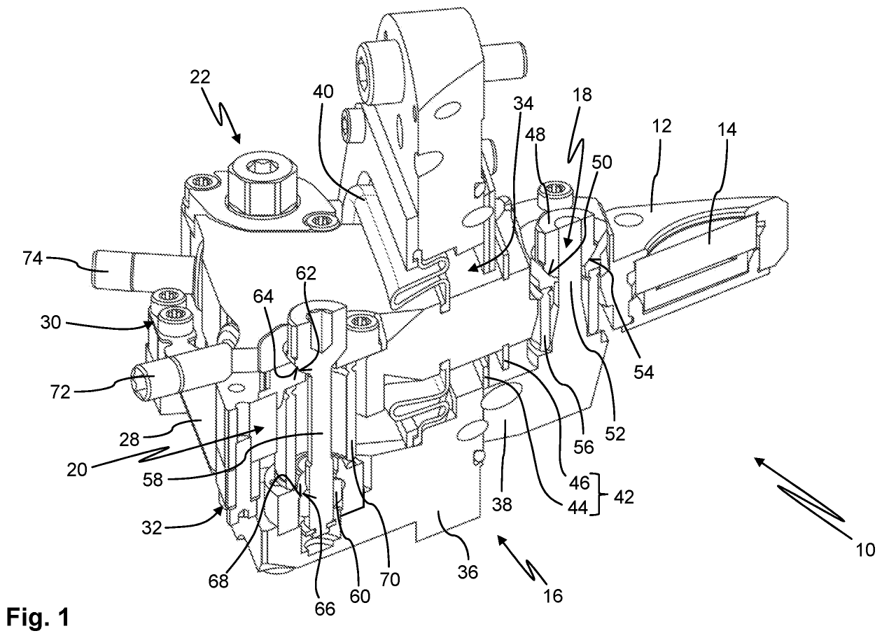

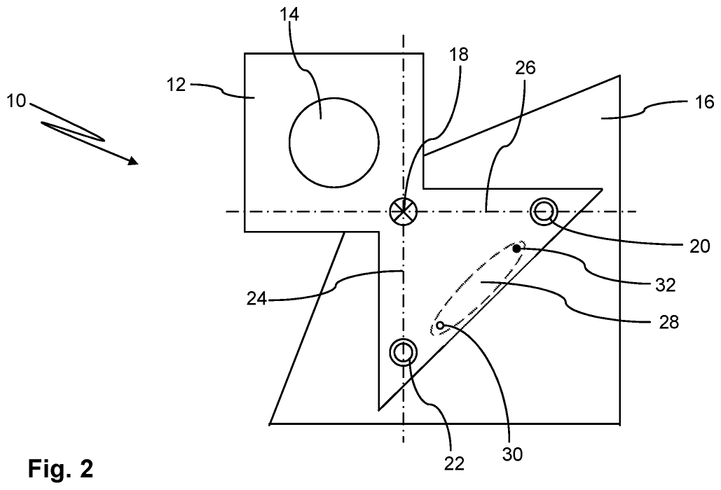

FIG. 1 shows an adjustable optical arrangement 10. FIG. 2 illustrates in an abstract manner the main construction of the optical arrangement 10.

The optical arrangement 10 has an optics mount 12. An optical element 14 is held at the optics mount 12. The optical element 14 is a mirror in this case. Alternatively, the optical element could be a transmissive element, for example a beam splitter (not illustrated in more detail). The optical element 14 can be placed in a receiving cutout of the optics mount 12.

The optical arrangement 10 furthermore has a holding structure 16. The optics mount 12 with the optical element 14 can be adjusted with respect to the holding structure 16. To allow the optics mount 12 to be tilted with respect to the holding structure 16, the optics mount 12 is held at the holding structure 16 in a ball joint 18. The ball joint 18 permits a rotational relative movement of the optics mount 12 with respect to the holding structure 16 in all three (rotational) degrees of freedom. Translational displacement of the optics mount 12 with respect to the holding structure 16 is not possible at the ball joint 18.

The optical arrangement 10 has a first adjustment device 20 and a second adjustment device 22. By actuating the first adjustment device 20, the optics mount 12 is pivotable with respect to the holding structure 16 about a first axis 24. By actuating the second adjustment device 22, the optics mount 12 is pivotable with respect to the holding structure 16 about a second axis 26. The first axis 24 is defined here by a straight line through the ball joint 18 and the second adjustment device 22. The second axis 26 is defined here by a straight line through the ball joint 18 and the first adjustment device 20. The first and the second axis 24, 26 can enclose, between the two adjustment devices 20, 22, an angle of, for example, 90°. However, smaller or greater angles are also possible.

The ball joint 18 is arranged between the optical element 14 and the first and the second adjustment device 20, 22. A distance, in particular of a center, of the optical element 14 from the ball joint 18 is smaller than a distance (of the center) of the optical element 14 from the first adjustment device 20. Likewise, the distance (of the center) of the optical element 14 from the ball joint 18 is smaller than a distance (of the center) of the optical element 14 from the second adjustment device 22. In the illustrated embodiment, in particular the point having the shortest distance from the optical element 14 (in particular from the center thereof) lies, viewed from the first adjustment device 20 on the other side of the ball joint 18, on the second axis 26. Accordingly, the point having the smallest distance from the optical element 14 (in particular from the center thereof) lies, viewed from the second adjustment device 22 on the other side of the other side of the ball joint 18, on the first axis 24. Viewed from the optical element 14, both adjustment devices 20, 22 are arranged behind the ball joint 18.

A guide element 28 is provided in order to define the alignment of the optics mount 12 relative to the holding structure 16 with respect to rotations about a third axis. In this case, the third axis extends perpendicularly to the first and the second axis 24, 26, through the ball joint 18 (perpendicularly to the plane of the drawing in FIG. 2). The guide element 28 can be in the form of a leaf spring. On one end, the guide element 28 is fixed to the holding structure 16 at a first attachment location 30. At the other end, the guide element 28 is fixed to the optics mount 12 at a second attachment location 32. A straight-line extends, at a distance from the ball joint 18, through the two attachment locations 30, 32 of the guide element 28. This straight line can extend parallel to a connection line of the two adjustment devices 20, 22. Since the guide element 28 is embodied to be longitudinally rigid, it prevents a rotation of the optics mount 12 with respect to the holding structure 16 about the third axis. In order to enlarge the distance of the guide element 28 from the ball joint 18 and thus attain particularly precise guidance of the optics mount 12, the guide element 28 can be arranged, viewed from the optical element 14, behind the two adjustment devices 20, 22.

The holding structure 16 can have a cutout 34 (cf. FIG. 1), through which the optics mount 12 projects. It should be noted that the holding structure 16 can be formed in multiple parts. In particular, points of attack of the two adjustment devices 20, 22 at the holding structure 16 and the cutout 34 can be provided at a first component 36 of the holding structure 16. The ball joint 18 can be provided at a second component 38 of the holding structure 16. If the holding structure 16 is formed from multiple parts, the components 36, 38 thereof are fixedly connected to each other and in particular not movable relative to each other.

The optics mount 12 in this case is formed with a single-piece main body. Alternatively, a main body of the optics mount could be embodied in multiple parts and be divided in particular between the adjustment devices 20, 22 and the ball joint 18 or the optical element 14 (not illustrated in more detail).

In the region of the cutout 34, the holding structure 16 continuously engages around the perimeter of the optics mount 12. A gas seal 40 can be provided at the cutout 34. The gas seal 40 can be embodied in the manner of folding bellows. The gas seal 40 separates a space in which the optical element 14 is arranged and that typically contains a protective gas from an environment in which the adjustment devices 20, 22 are freely accessible.

Furthermore, an optical screen 42 is provided at the cutout 34. The screen 42 prevents light, in particular laser light, from entering the environment with the adjustment devices 20, 22 through the cutout 34. The optical screen 42 can have at least a first sheet-metal element 44, which is attached to the holding structure 16. The optical screen 42 can furthermore have at least a second sheet-metal element 46, which is attached to the optics mount 12. The sheet-metal elements 44, 46 overlap one another, such that light cannot exit through the cutout 34.

In order to cause small movements at the gas seal 40 and the screen 42 during the adjustment of the optics mount 12 relative to the holding structure 16, the cutout 34 is arranged close to the ball joint 18. The arrangement of the adjustment devices 20, 22 outside the space that is also delimited by the holding structure 16 and in which the optical element 14 is located makes it possible to keep the cutout 34 small. In this way, the gas seal 40 and the screen 42 can also be designed with a small perimeter length.

The ball joint 18 can be embodied with a fixing nut 48. The fixing nut 48 has a spherical joint surface 50. In the illustrated exemplary embodiment, the fixing nut 48 is screwed onto a stud 52 of the holding structure 16. The stud 52 is here formed in one piece with the second component 38 of the holding structure 16. The spherical joint surface 50 of the fixing nut 48 is supported in a conical receptacle 54 of the optics mount 12. In the region of the ball joint 18, the optics mount 12 and the holding structure 16 are preloaded away from each other by a spring element 56, which is illustrated schematically in the manner of a case in FIG. 1. The spring element 56 can be embodied in the form of a coil spring. The spring element 56 can engage around the stud 52. The preloading of the spring element 56 is selected to be sufficiently great, for example approximately 240 N, that, when loads occur during operation, a line-type contact between the fixing nut 48 and the conical receptacle 54 is always ensured. With this construction, precise, rigid and easily adjustable mounting of the optics mount 12 at the holding structure 16 in the ball joint 18 can be achieved.

The two adjustment devices 20, 22 can have the same structural design. The adjustment devices 20, 22 can be embodied for changing the distance between their respective points of attack at the optics mount 12 and at the holding structure 16. In other words, the adjustment devices 20, 22 can be embodied for performing a length change.

The adjustment devices 20, 22 in the present case each have an adjustment screw 58 and a retaining nut 60. The effective length of the adjustment devices 20, 22 is modifiable by rotating the adjustment screw 58 and the retaining nut 60 with respect to one another. The adjustment screws 58 in each case have a spherical head section 62. The spherical head sections 62 of the adjustment screws 58 can be supported in each case in a (further) conical receptacle 64 of the optics mount 12. The retaining nuts 60 each have a spherical contact surface 66. The spherical contact surface 66 of the retaining nuts 60 can be supported in each case in a conical receptacle 68 of the holding structure 16. It is to be understood that the arrangement of the adjustment screws 58 and retaining nuts 60 can also be the other way around, which means that the head sections 62 are supported at the holding structure 16 and the contact surfaces 66 are supported at the optics mount (not illustrated).

In the region of the adjustment devices 20, 22, the optics mount 12 and the holding structure 16 are preloaded away from each other by spring elements 70. The spring element 70 of the first adjustment device 20 is schematically illustrated in the shape of a case in FIG. 1. The spring elements 70 can be embodied in each case as a coil spring. The spring elements 70 can in each case engage around the associated adjustment screw 58. The preloading of the spring elements 70 is selected to be sufficiently large, for example approximately 150 N, such that, when loads occur during operation, a linear contact of the head sections 22 and contact surfaces 66 and the respective conical receptacles 64, 68 is always ensured. With this construction, precise, rigid and statically determined mounting of the optics mount 12 at the holding structure 16 can be attained. Since the adjustment devices 20, 22 restrict or set in each case only a single degree of freedom, the adjustment of the optical arrangement 10 is easily possible and tensioning of the optics mount 12, which could have a negative effect on the imaging quality of the optical element 14, can be reliably avoided.

The attachment of the optics mount 12 to the holding structure 16, which is both rigid and free of stress, makes it possible to connect coolant hoses (not illustrated) to the optics mount 12 without negatively impacting the precision of the alignment of the optics mount 12 with the optical element 14. For this purpose, two coolant connectors 72, 74 are provided on the optics mount 12. A coolant channel (not illustrated in more detail) extends in the optics mount 12. The coolant channel connects the two coolant connectors 72, 74 to one another. It is conceivable that the coolant channel extends directly past the optical element 14 and is in part delimited thereby.

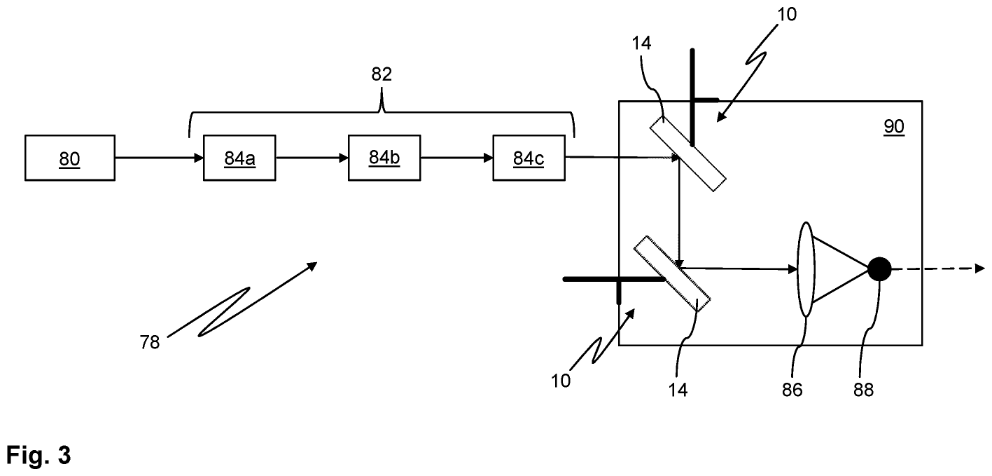

FIG. 3 shows an apparatus 78 for generating extreme ultraviolet radiation. The apparatus has a laser light source 80 and an amplification arrangement 82 having three optical amplifier stages 84a, 84b, 84c. A laser beam, which has been emitted by the laser light source 80 and amplified by the amplifier arrangement 82, is directed at a target 88 by means of two adjustable optical arrangements 10, described above, and a focusing optical unit 86. The focusing optical unit 86 can be a lens. The target 88 can consist of tin. When irradiated with the laser beam, the material of the target 88 transitions into a plasma state and emits extreme ultraviolet radiation (cf. dashed arrow).

At least the target 88, the focusing optical unit 86 and the optical elements 14 of the two optical arrangements 10 are arranged in a vacuum chamber 90. The vacuum chamber 90 can contain a protective gas at low pressure. A wall of the vacuum chamber 90 can also be formed by the regions of the holding structures 16 that have the cutout 34. The holding structures 16 can be attached outside of the vacuum chamber 90 or to the wall thereof. The optics mounts 12 project through the wall of the vacuum chamber 90 at the cutout 34 of the holding structures 16. The optical elements 14, and in this case the ball joints 18 as well, are arranged each inside the vacuum chamber 90. The adjustment devices 20, 22, and in this case the coolant connectors 72, 74 as well, are arranged in each case outside the vacuum chamber 90. The adjustment devices 20, 22 are therefore easily accessible for adjustment purposes.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Adjustable optical arrangement 10
Optics mount 12
Optical element 14
Holding structure 16
Ball joint 18
First adjustment device 20
Second adjustment device 22
First axis 24
Second axis 26
Guide element 28
First attachment location 30 of the guide element 28
Second attachment location 32 of the guide element 28
Cutout 34
First component 36 of the holding structure 16
Second component 38 of the holding structure 16
Gas seal 40
Screen 42
First sheet-metal element 44 of the screen 42
Second sheet-metal element 46 of the screen 42
Fixing nut 48
Joint surface 50 of the fixing nut 48
Stud 52
Receptacle 54 of the optics mount 12
Spring element 56 of the ball joint 18
Adjustment screw 58
Retaining nut 60
Head section 62
Further receptacle 64 of the optics mount 12
Contact surface 66
Receptacle 68 of the holding structure 16
Spring elements 70 of the adjustment devices 20, 22
Coolant connectors 72, 74
Apparatus 78 for generating extreme ultraviolet radiation
Laser light source 80
Amplifier arrangement 82
Amplifier stages 84a, 84b, 84c
Focusing optical unit 86
Target 88
Vacuum chamber 90

1. An adjustable optical arrangement, comprising:
an optics mount;
an optical element held at the optics mount;
a holding structure having a ball joint for receiving the optics mount;
a ball joint holding the optics mount at the holding structure ;
a first adjustment device configured to pivot the optics mount with respect to the holding structure about a first axis; and
a second adjustment device configured to pivot the optics mount with respect to the holding structure about a second axis,
wherein the ball joint is disposed between the optical element and the first and the second adjustment device.

2. The arrangement as claimed in claim 1, further comprising a longitudinally rigid guide element guiding the optics mount at the holding structure.

3. The arrangement as claimed in claim 2, wherein the guide element is disposed behind the first and/or the second adjustment device relative to the ball joint.

4. The arrangement as claimed in claim 1, wherein the optics mount projects through a cutout of the holding structure.

5. The arrangement as claimed in claim 4, wherein the holding structure engages around the optics mount between the ball joint and the first and second adjustment devices.

6. The arrangement as claimed in claim 4, further comprising a gas seal disposed between the optics mount and the holding structure.

7. The arrangement as claimed in claim 4, further comprising an optical screen disposed at the cutout.

8. The arrangement as claimed in claim 1, wherein the optics mount has a coolant channel.

9. The arrangement as claimed in claim 1, wherein at least one of the first or the second adjustment device includes an adjustment screw and a retaining nut.

10. The arrangement as claimed in claim 9, wherein the adjustment screw includes a rotationally ellipticalor spherical head section supported in a conical receptacle, of the optics mount.

11. The arrangement as claimed in claim 9, wherein the second retaining nut includes a rotationally elliptical or spherical contact surface supported in a conical receptacle of the holding structure.

12. The arrangement as claimed in claim 1, wherein the optics mount and the holding structure are preloaded in a direction opposite from one another.

13. The arrangement as claimed in claim 12, wherein a preloading force at each of the two adjustment devices is at least 100 N.

14. The arrangement as claimed in claim 1, wherein the ball joint includes a fixing nut screwed onto a stud of the holding structure and has a rotationally ellipticalor spherical joint surface supported in a conical receptacle of the optics mount.

15. The arrangement as claimed in claim 1, further comprising a laser light source for emitting a laser beam and a target, wherein the optical element is arranged in the path of the laser beam in order to direct the laser beam onto the target.
